(19) United States
(12) Patent Application Publication
(10) Pub. No.: US 2026/0074970 A1
(43) Pub. Date: Mar. 12, 2026

(54) LOG GENERATION MANAGEMENT IN WIRELESS NETWORKS

(71) Applicant: Charter Communications Operating, LLC, St. Louis, MO (US)

(72) Inventors: Sushma Sangameswaran, Aurora, CO (US); Manan Rajendrakumar Shah, Greenwood Village, CO (US)

(21) Appl. No.: 18/883,282

(22) Filed: Sep. 12, 2024

(51) Int. Cl. H04L 43/04

(52) U.S. Cl. CPC H04L 43/04

(57) ABSTRACT

Multiple network nodes in a network environment register themselves with a network repository node. Each of the network nodes provides a new logging service through a corresponding communication interface. The network environment further includes a log management resource. The log management resource receives multiple instructions specifying collection of log information in a wireless network including the multiple network nodes. Via a first instruction of the multiple instructions, the communication management resource obtains a first unique identifier value assigned for communicating with a first wireless network node of the multiple wireless network nodes. The log management resource utilizes the first unique identifier value to transmit communications to the first wireless network node. The communications prompt the corresponding network node to produce the log information as specified by the multiple instructions. The log management may control conveyance of the produced log information to a specified server resource.

### BACKGROUND

A wireless network such as 5G may include many core Network Functions (NF) and have different methods to enable and collect log information from them. 5GC network functions are typically microservice based, where each functionality of NF has several pods.

According to conventional techniques, an administrator of a wireless network must manually login to each network function and update multiple configurations to change pod log level (Info, Debug, Warning) collections or to enable the PCAP (packet capture) generation using the solutions supported by different vendors.

### BRIEF DESCRIPTION OF EXAMPLES

Techniques herein include providing improved wireless connectivity in a network. to support better use of available wireless resources.

For example, a log management resource receives multiple instructions specifying collection of log information in a wireless network including multiple network functions (a.k.a., log services). In accordance with the multiple instructions, the management resource obtains a first unique identifier value assigned for communicating with a first network function of the multiple network functions. The management resource utilizes the first unique identifier value to transmit communications to the first network function (logging service). The communications are transmitted in furtherance of producing/collecting the log information as specified by the multiple instructions.

In one example, the first network function (such as a logging function or other suitable entity) associated with the wireless network is a new wireless network function supporting the collection or generation of the log information.

In another example, the multiple network functions reside in the respective wireless network and support wireless connectivity of one or more mobile communication devices to a corresponding wireless network providing access to a remote network. The log information can be derived from monitoring operations associated with a network node implementing the first network function (such as a first logging function). The first network function (such as a first logging function) is one of multiple network functions (such as multiple logging functions) supporting the wireless connectivity between the mobile communication devices and the corresponding wireless network.

As previously discussed, the log management resource as discussed herein can be configured to obtain the first unique identifier value, which may include the log management resource or other suitable entity transmitting notification of an identity of the first network function of interest over a network to a management entity such as a network repository function. The management entity (such as a network repository function or network resource repository) can be configured to map the identity of the first network function of interest as specified by the notification to the first unique identifier value. In response to the log management resource transmitting the notification to the management entity, the log management resource receives the first unique identifier value from the management entity.

In accordance with further examples, the first unique identifier value assigned to the first network function can be configured to include a first network address assigned to communicate with a communication interface associated with the first network function. The log management resource can be configured to transmit the communications such as log commands to the communication interface of the first network function assigned the first unique identifier value and corresponding first network function. The log commands control collection of desired log information by the first network function.

Yet further, the management resource can be configured to transmit a first communication to the first network function. The first communication may include the first unique identifier value as a destination in which to deliver the first communication. The first communication can be configured to notify the first wireless network function to provision storage resources to store the collection of log information as specified by the multiple instructions. Additionally, the management resource can be configured to transmit a second communication to the first network function. The second communication can be configured to include the first unique identifier value as a destination in which to deliver the second communication. The second communication can be configured to notify the first network function of a time range in which to collect the log information for storage in the storage resources.

In still further examples, the log management resource as discussed herein can be configured to transmit a first communication to a communication interface of the first network function assign the first unique identifier value. The first communication can be configured to include the first unique identifier value as a destination in which to deliver the first communication to the communication interface. The first communication can be configured to notify the first network function of a time range in which to collect the log information for storage in the storage resources.

Still further examples as discussed herein include the management resource controlling execution of enable and disable operational states of the first wireless network function in accordance with one or more instructions of the multiple instructions.

Via the communications transmitted to the first network function, the log management resource as discussed herein can be configured to notify the first wireless network function of a storage location in which to store the collection of log information.

In another example, the one or more communications transmitted to the first network function cause the first wireless network function to produce the collection of log information as specified by the multiple instructions. The first wireless network function can be configured to produce a file including the collection of log information as indicated by the log management resource. The wireless network function or other suitable entity can be configured to produce a filename associated with the file based on attributes as specified by the multiple instructions.

Note that any of the resources as discussed herein can include one or more computerized devices, mobile communication devices, sensors, servers, base stations, wireless communication equipment, communication management systems, log management system, log management resource, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium or computer readable hardware storage medium on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that supports operations as discussed herein.

One example includes a computer readable storage medium and/or system having instructions stored thereon. The instructions, when executed by the computer processor hardware, cause the computer processor hardware (such as one or more co-located or disparately processor devices or hardware) to: receive multiple instructions specifying collection of log information associated with a wireless network supporting wireless network access; obtain a first unique identifier value assigned for communicating with a communication interface of a first network node of multiple network nodes in the wireless network; and utilize the first unique identifier value to transmit communications to the communication interface of the first network node, the communications transmitted to produce the log information.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved wireless connectivity and management of network nodes in a wireless network. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a log management resource managing collections of log information associated with multiple interconnected network nodes supporting wireless communications as discussed herein.

FIG. 2 is an example detailed diagram illustrating implementation of the communication management system (log management system) to manage collection of log information associated with network nodes in a first wireless network as discussed herein.

FIG. 3 is an example diagram illustrating management of network addresses of different processing services (network functions) provided by the multiple network nodes in a first wireless network as discussed herein.

FIG. 4 is an example diagram illustrating newly created network functions and corresponding communication interfaces as discussed herein.

FIG. 5 is an example diagram illustrating implementation of a management resource and multiple network nodes at multiple wireless network sites as discussed herein.

FIG. 6 is an example diagram illustrating example computer hardware and software operable to execute operations according to examples herein.

FIG. 7 is an example diagram illustrating a method according to examples herein.

The foregoing and other objects, features, and advantages of the invention be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DESCRIPTION OF EXAMPLES

Multiple network nodes in a network environment register themselves with a network repository node (a.k.a., a network repository function). Each of the network nodes provides a new network function such as a logging service or logging function through a corresponding communication interface. The network environment further includes a log management resource that manages generation of logs. Each of the logs as discussed herein can include computer-generated records information about a wireless network's activities, operations, status, usage patterns, etc. The log management resource receives multiple instructions specifying collection of log information in a wireless network including the multiple network nodes. The multiple network nodes support wireless connectivity associated with one or more mobile communication devices. Via the multiple instructions, the log management resource obtains a first unique identifier value assigned for communicating with a network function at a first wireless network node of the multiple wireless network nodes. The log management resource utilizes the first unique identifier value to transmit communications to the network function at the first wireless network node. The communications prompt the corresponding network node to produce the log information in a manner as specified by the multiple instructions. Via the multiple instructions, the log management may control conveyance of any produced log information to a specified server resource or store the log information locally.

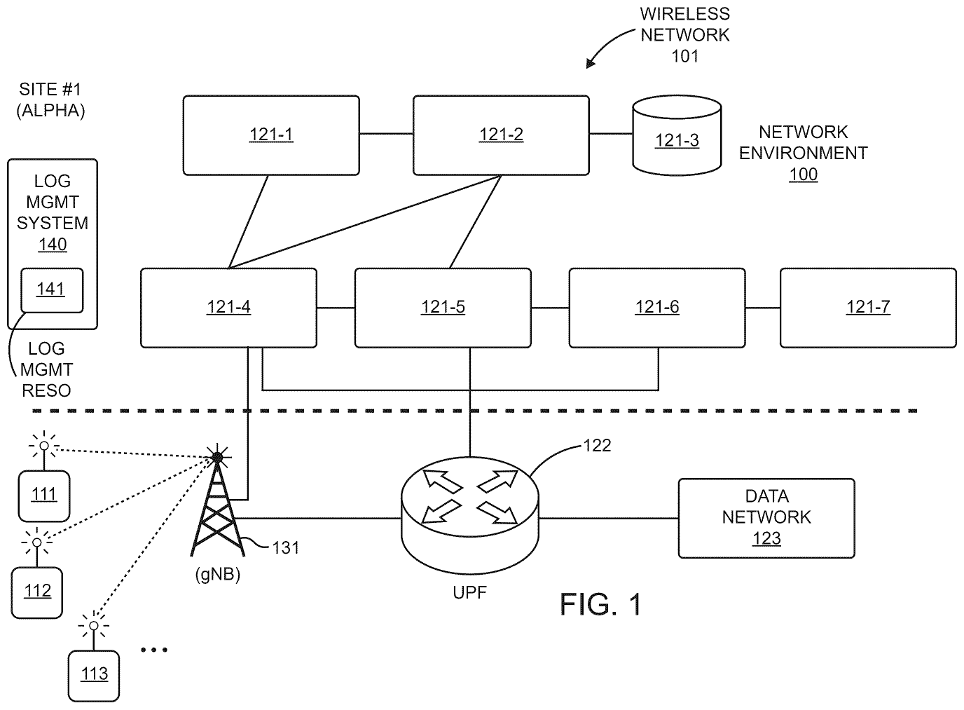

Now, with reference to the drawings, FIG. 1 is an example diagram illustrating implementation of a log management system and a corresponding network environment including multiple network nodes associated with a first wireless network site as discussed herein.

As shown in this example, the wireless network environment 100 includes log management system 140 and multiple network nodes in a wireless network 101 supporting wireless communications. The log management system 140 includes log management resource 141. As further discussed herein, the log management system 140 and/or corresponding log management resource 141 are in communication with each of the network nodes in the wireless network 101.

More specifically, the wireless network 101 in this example can be configured to network node 121-1 (such as AUSF or Authentication Server Function), network node 121-2 (such as UDM or Unified Data Management), network node 121-3 (UDR or Unified Data Repository), network node 121-4 (such as AMF or Access and Mobility Management Function), network node 121-5 (such as SMF or Session Management Function), network node 121-6 (such as PCF or Policy Control Function), network node 121-7 (such as AF or Application Function), and so on. The wireless network 101 can be configured to include any number of different network nodes supporting wireless services.

The network environment 100 further includes one or more wireless base stations (such as gNodeBs) such as including wireless base station 131.

Yet further, the network environment 100 includes network resource 122 such as a UPF (User Plane Function) resource. The network resource 122 can be configured to process network data and connect the Radio Area Network (RAN) such as the wireless base station 131 to the data network 123 such as the Internet.

As further shown, the network environment 100 may include any number of communication devices such as mobile communication device 111, mobile communication device 112, mobile communication device 113, etc. Via communications supported by a combination of the wireless base station 131, network resource 122, and network nodes (121-1, 121-2, 121-3, etc.) in the wireless network 101, each of the mobile communication devices is able to use services provided by the wireless network 101 or the data network 123.

Accordingly, via communications through the wireless base station 131, each of the mobile communication devices 111, 112, 113, etc., has access to the wireless network 101 as well as the data network 123.

It is desirable to manage or at least monitor operation of the different network nodes in the network environment 100. One way to monitor operation of the network nodes is to communicate with each of the network nodes to retrieve log information. The log information indicates may include any suitable information such as status information or include attributes of services or operations supplied by a respective network node.

As further shown, the network environment 100 includes the log management system 140. As its name suggests, the log management system 140 supports generation and/or collection of log information associated with any of the resources (such as network notes 121 or other entities) in the network environment 100.

Note that each of the different components in network environment 100 can be implemented via hardware, software, or a combination of both hardware and software. More specifically, log management system 140 can be configured as log management hardware, log management software, or a combination of log management hardware and log management software; each of the network nodes 121 can be configured as or include, software, or a combination of hardware and software; and so on.

### Logging Function

In one example, the wireless network 101 is a so-called 5G network. Each of the different network nodes 121 can be configured to implement different network functions such as log services (via one or more so-called network function pods) to collect and/or distribute respective log information.

In contrast to conventional techniques of manually communicating with each network node to change pod log level (Info, Debug, Warning) configurations or distribute log information from one or more respective servers, examples herein include novel management of producing log information such as including: i) implementation of one or more novel API/log services in each of the network nodes, and ii) implementation of a log management resource that triggers one or more of collection, storage, and distribution of log information at each of the network nodes.

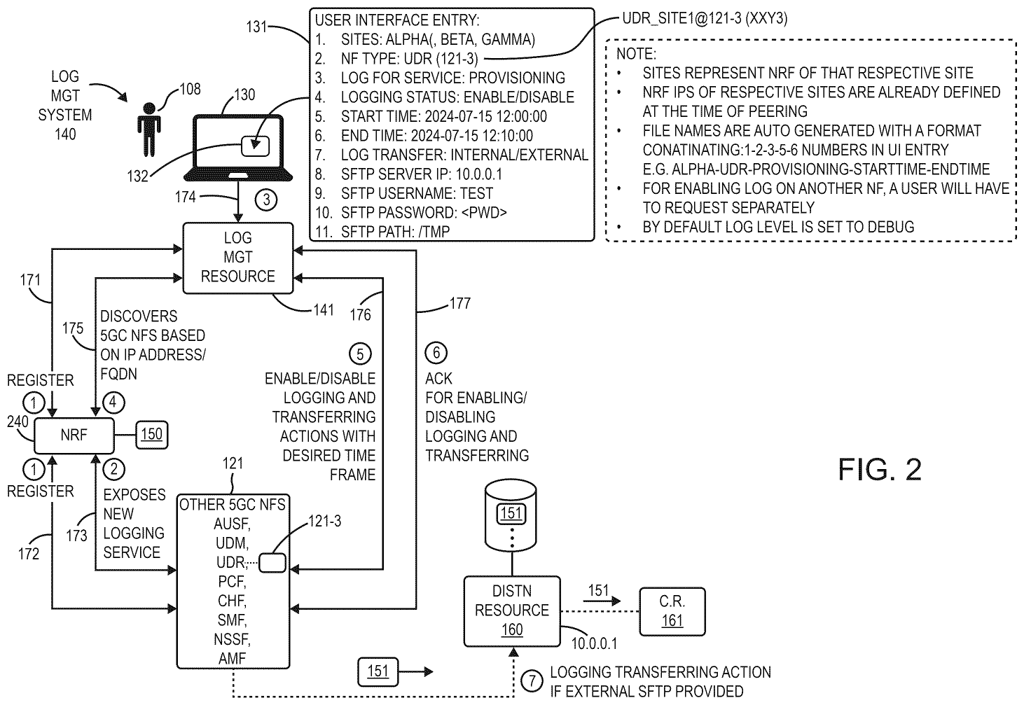

FIG. 2 is an example diagram illustrating multiple interconnected network nodes supporting wireless communications as discussed herein.

In this example, the log management system 140 controlling generation of log information associated with the wireless network 101 includes log management resource 141, display screen 130, network resource repository 240 such as network repository function, multiple network nodes 121 (such as network functions), and distribution resource 160.

Note that each of the different components in network environment 100 can be implemented via hardware, software, or a combination of both hardware and software. More specifically, log management resource 141 can be configured as log management hardware, log management software, or a combination of log management hardware and log management software; network resource repository 240 such as a network repository function can be configured as hardware, software, or a combination of hardware and network software; each of the network nodes 121 can be configured as or include, software, or a combination of hardware and software; and so on.

Techniques as discussed herein include a novel communications interface (such as API or Application Programming Interface) for Logging Services provided by each of the network nodes in the wireless network 101.

For example, as previously discussed, each of the network nodes 121 in the wireless network 101 can be configured to execute one or applications (logging service application or other network function).

The one or more applications at each of the network nodes (network functions) can be configured to expose a new communication interface and corresponding logging service to enable logging and change of the log levels associated with the respective network node. Using such a service (a.k.a., network function), log management resource 141 can be configured to change the default log level (i.e., collected log information) on the applications (at the network nodes) for the required pods without logging into the network node. Each new log service provided by the new network function application on the network node can be configured to include a respective service name (associated with pods) and log level as input to enable a respective log generation for status information of interest for a specified duration. As further discussed herein, a request communicated from the log management resource 141 to a respective network node and corresponding network function may optionally indicate where to send any generated pod logs (log information).

Yet further, as discussed herein, the log information such as log information 151 generated by a respective network node and corresponding network function (such as application) can be stored locally at the network node or the log information can be communicated to a remote resource such as an external Secure File Transfer Protocol server. If the network nodes expose tracing functionality for collecting PCAPs (vTAP), the log management resource 140 can be used to invoke that functionality on the network nodes as well. This may require an external trigger notification from the log management resource 140 (a.k.a., Logging Function) for enabling/disabling and possibly exporting the collected logs to an external destinations such as a SFTP Server. Note that availability of a respective new Logging Service associated with a network node will be communicated to the network repository resource 240 (a.k.a., Network Repository Function), so the new log management resource 141 can discover via inquiry communications to the network repository resource 240.

New Logging Function such as Provided by the Log management Resource 141 In one example, the log management resource 141 can be configured as a network function to control logging and transferring a variety of network node logs in an automated, centrally controlled, timed, collectively managed, manner for the 5G NFs registered in the NRF (240).

For example, as further discussed herein, the user 108 (such as a network administrator) may create a so-called user interface entry 131 to manage collection of log information from one or more network nodes 121 in the wireless network 101.

The user interface entry 131 (a.k.a., Logging Function User Interface) entry can be configured to request logs and corresponding log information to be collected from one or more wireless network sites, a particular network node of the wireless network of interest, and/or a particular NF type and for a service name.

In one example, the user interface entry 131 is configured to specify a start and end time associated with log information collection to limit excessive data collection. As further discussed herein, the user interface entry 131 also may indicate other control parameters such as a log transfer location where the corresponding log information is to be stored (i.e., whether to store the generated log information locally in the network repository resource 140 or forward the requested log information to a remote distribution resource 160 such as an external SFTP server).

The user interface entry 131 may indicate an identity of a network address associated with a target SFTP server (such as distribution resource 160) to which the log information is directed.

Additionally, the network node and corresponding network function at the network node can be configured to create the log information and forward it to the distribution resource 160. Storage of the log information at the distribution resource 160 may require an appropriate IP Address, username, password, and path specifier (such as network address 10.0.0.1) supporting communication of any collected log information from the to the target distribution resource 160. In one example, the storage of log information via the distribution resource 160 may require an SFTP network address, username, password, and path (for example, the path may indicate where on the corresponding SFTP server the logs are going to be stored). In other words, the log management resource 141 can be configured to communicate username, password, and path specifier to the respective logging service at the network node. After generating the log information, the respective logging service uses the IP Address, username, password, and path specifier as a way to communicate the generated log information from the respective logging service at the network node to the distribution resource 160. As its name suggests, the distribution resource 160 makes the logging information such as log file 151 retrievable by any appropriate communication resource such as communication resource 161.

As further discussed herein, for the one or more site name(s) as specified by the user interface entry 131, the log management resource 140 communicates a discovery message to the network repository function 240 associated with the specified wireless network site. Note that the discovery message communicated from the log management resource 141 to the network repository resource 240 may have a request for the network function type as specified in the user interface entry 131. The network repository function 240 be configured to respond with a communication interface information such as an IP Address/FQDN for a new logging service available from a given network node. The log management resource 141 can be configured to use the discovered IP Address/FQDN (unique network address) and service to enable/disable collection of logging information and transferring of same to a target resource such as the distribution resource 160.

More specific details of the log management resource 141, network repository resource 240, and network nodes 121 is further discussed below.

### Call Flow Explained

1. As a more specific example, via communications 172 (such as registration) between each of the network nodes 121 and the network resource repository 240, one or more of the network nodes 121 register themselves with the network repository resource 240. Via communications 171, the log management resource 140 registers itself with the network repository resource 240.

Accordingly, the network resource repository 240 is aware of the available network functions supported by the network nodes 121. As further discussed herein, the network resource repository 240 can be configured to produce map information 150 or other suitable information to keep track of the available network functions provided by each of the network nodes.

2. Via communications 173, the corresponding network nodes 121 advertise their services (processing capabilities) and corresponding communication interface information (such as API which may include a unique IP Address / fully qualified domain name assigned to the network functions communication interface) to the network repository resource 240. Thus, the network resource repository 240 is aware of the one or more available network functions (such as applications) supported by each of the network nodes as well as a corresponding communication interface to access those network functions. The communication interface information associated with the available logging services enables access to those logging service applications and corresponding logging services.

Note that the network repository resource 240 produces the map information 150 based on the registration of the network nodes 121 and corresponding logging services with the network repository resource 240.

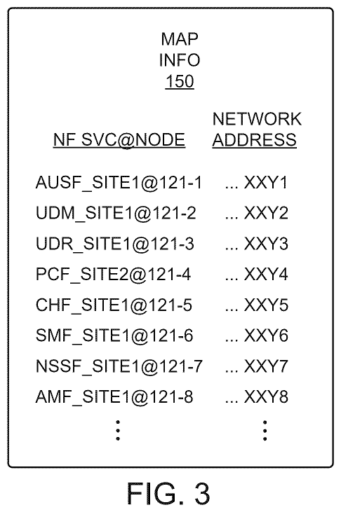

For example, assume that the network node 121-1 establishes the new network logging service AUSF_SITE1 at the network node 121-1. In such an instance, the network node 121-1 registers the logging service AUSF-SITE1 and its availability to the network repository resource 240. The network node 121-1 also notifies the network repository resource 240 that the logging service AUSF-SITE1 is available via communications directed to the network address XXY1 (assigned to the communication interface associated with the service AUSF-SITE1, where the network address XXY1 may include or be a fully qualified domain name as well as corresponding port associated with the network node 121-1). The network address XXY1 therefore enables the log management resource 141 to communicate directly with the logging service AUSF-SITE1 at the network node 121-1. In response to receiving the notification of the logging service AUSF-SITE1, the network repository resource 240 produces the map information 150 (in FIG. 3) to indicate the availability of the logging service AUSF-SITE1 at the network node 121-1 via the communication interface at the network node 121-1 assigned the network address XXY1. As discussed herein, the log management resource 141 can be configured to communicate directly with the logging service (network function) AUSF-SITE1 via communications transmitted directly to the network address XXY1.

Assume that the network node 121-2 establishes the new network logging service UDM_SITE1 at the network node 121-2. In such an instance, the network node 121-2 registers the logging service UDM-SITE1 and its availability to the network repository resource 240. The network node 121-2 also notifies the network repository resource 240 that the logging service UDM-SITE1 is available via communications directed to the network address XXY2 (which may include or be a fully qualified domain name as well as corresponding port associated with the network node 121-2) to communicate with the logging service UDM-SITE1 at the network node 121-2. In response to receiving the notification of the logging service UDM-SITE1, the network repository resource 240 produces the map information 150 (in FIG. 3) to indicate the availability of the logging service UDM-SITE1 at the network node 121-2 via the communication interface at the network node 121-2 assigned the network address XXY2. As discussed herein, the log management resource 141 can be configured to communicate directly with the logging service (network function) UDM-SITE1 via communications transmitted directly to the network address XXY2.

Assume that the network node 121-3 establishes the new network logging service UDR_SITE1 at the network node 121-3. In such an instance, the network node 121-3 registers the logging service UDR-SITE1 and its availability to the network repository resource 240. The network node 121-3 also notifies the network repository resource 240 that the logging service UDR-SITE1 is available via communications directed to the network address XXY3 (which may include or be a fully qualified domain name as well as corresponding port associated with the network node 121-3) to communicate with the logging service UDR-SITE1 at the network node 121-3. In response to receiving the notification of the logging service UDR-SITE1, the network repository resource 240 produces the map information 150 (in FIG. 3) to indicate the availability of the logging service UDR-SITE1 at the network node 121-3 via the communication interface at the network node 121-3 assigned the network address XXY3. As discussed herein, the log management resource 141 can be configured to communicate directly with the logging service (network function) UDR-SITE1 via communications transmitted directly to the network address XXY3.

Assume that the network node 121-4 establishes the new network logging service PCF_SITE1 at the network node 121-4. In such an instance, the network node 121-4 registers the logging service PCF-SITE1 and its availability to the network repository resource 240. The network node 121-4 also notifies the network repository resource 240 that the logging service PCF-SITE1 is available via communications directed to the network address XXY4 (which may include or be a fully qualified domain name as well as corresponding port associated with the network node 121-4) to communicate with the logging service PCF-SITE1 at the network node 121-4. In response to receiving the notification of the logging service PCF-SITE1, the network repository resource 240 produces the map information 150 (in FIG. 3) to indicate the availability of the logging service PCF-SITE1 at the network node 121-4 via the communication interface at the network node 121-4 assigned the network address XXY4. As discussed herein, the log management resource 141 can be configured to communicate directly with the logging service (network function) PCF-SITE1 via communications transmitted directly to the network address XXY4.

Assume that the network node 121-5 establishes the new network logging service CHF_SITE1 at the network node 121-5. In such an instance, the network node 121-5 registers the logging service CHF-SITE1 and its availability to the network repository resource 240. The network node 121-5 also notifies the network repository resource 240 that the logging service CHF-SITE1 is available via communications directed to the network address XXY5 (which may include or be a fully qualified domain name as well as corresponding port associated with the network node 121-5) to communicate with the logging service CHF-SITE1 at the network node 121-5. In response to receiving the notification of the logging service CHF-SITE1, the network repository resource 240 produces the map information 150 (in FIG. 3) to indicate the availability of the logging service CHF-SITE1 at the network node 121-5 via the communication interface at the network node 121-5 assigned the network address XXY5. As discussed herein, the log management resource 141 can be configured to communicate directly with the logging service (network function) CHF-SITE1 via communications transmitted directly to the network address XXY5.

In this manner, via generation of the map information 150, the network repository resource 140 keeps track of the different available logging services as well as communication interfaces in which to communicate with those build the logging services.

3. Via the graphical user interface 132 (associated with the log management resource 140) on display screen 130, the user 108 can create a logging service request for execution by one or more applications (network functions) available on the network nodes 121 via the user interface entry 131 (such as log generation instructions). In one example, the user interface entry 131 includes log executable instructions as follows:
instruction #1. Site Parameter: ALPHA such as site #1 associated with wireless network 101
instruction #2. NF Type: UDR
instruction #3. Log for service: provisioning
instruction #4. Logging Status: Enable / Disable
instruction #5. Logging Execution Start Time: 2024-07-15 12:00:00 PM
instruction #6. Logging Execution End Time: 2024-07-15 12:10:00 PM
instruction #7. Log Transfer: External to the distribution resource 160 as file name ALPHA-UDR-PROVISIONING-START TIME 2024-07-15 12:00:00 PM-END TIME 2024-07-15 12:10:00 PM (such as concatenation of information associated with instructions 1-2-3-5-6)
instruction #8. SFTP Server IP (a.k.a., Internet Protocol): IP address 10.0.0.1
instruction #9. SFTP UserName: Test
instruction #10. SFTP Password: <pwd12345>
instruction #11. SFTP Path:/tmp

Instruction #1 in the user interface entry 131 indicates the site parameter ALPHA (site #1, or wireless network 101) where the logging instructions in the user interface entry 131 are to be executed.

Instruction #2 indicates the network node 121-3 that is to execute the logging instructions.

Instruction #3 indicates the logging service such as provisioning (such as log service UDR-SITE1 provided by the network node 121-3). As previously discussed, the network function such as provisioning service is accessible communications to the network function or log service UDR-SITE1 via the network address XXY3 at the network node 121-3.

Instruction #4 indicates the logging status associated with the user interface entry 131.

Instruction #5 indicates the start time associated with execution of the instructions (such as collection of certain log information) in the user interface entry 131.

Instruction #6 indicates the end time associated with execution of the instructions (such as collection of certain log information) in the user interface entry 131.

Instruction #7 indicates that the collected log information is to be made available externally to the distribution resource 160. The network function UDR-SITE1 is notified to generate the log information (file) with file name ALPHA-UDR-PROVISIONING-2024-07-15 12:00:00-2024-07-15 12:10:00 (such as concatenation of instructions 1-2-3-5-6). As previously discussed, the text sequence “2024-07-15 12:00:00 PM” indicates the start time and the text sequence “2024-07-15 12:10:00 PM” indicates the end time associated with collection of log information.

Instruction #8 indicates the network address of the distribution resource 160 where the log information collected by the log service or network function UDR-SITE1 provided by the network node 121-3 is to be stored after the end time.

Instruction #9 indicates a username associated with the distribution resource 160.

Instruction #10 indicates the password associated with the distribution resource 160.

Instruction #11 indicates the path associated with the distribution resource 160 where logs are going to be stored.

4. Note that the log management resource 141 can be configured to specify different site parameters associated with one or more log execution requests.

For example, the log management resource 141 can be configured to use the site parameter (ALPHA or SITE1) from the request as specified by the user interface entry 131 to send a respective discovery request message to the network resource repository 240. The discovery request message transmitted in communications 175 from the log management resource 141 to the network resource repository 240 can be configured to indicate a respective logging service type and/or corresponding logging application for network function (i.e., UDR) indicating a specific logging service type (network function) for which the discovery request message is being sent. Further, via the response to the respective discovery request message from the network resource repository 240 to the log management resource 141 (such as in the communications 175), the network resource repository 240 provides an appropriate network address XXY3 of the logging service application UDR-SITE1 (the instruction #2 may indicate this specific network function) to be used by the log management resource 141 to produce the desired log information 151.

More specifically, via communications 175, the log management resource 141 communicates with the network repository resource 240 to learn of available logging services from the network nodes 121. In response to communicating a request for available services from the log management resource 141 to the network resource repository 240, the network repository resource 240 notifies the log management resource 141 of the available services (network functions) and network addresses (see map information 150) such as Internet Protocol Address information/fully qualified domain name to access those services such as network function AUSF-SITE1 at network node 121-1 accessible via network address XXY1, network function UDM-SITE1 at network node 121-2 accessible via network address XXY2, network function UDR-SITE1 at network node 121-3 accessible via network address XXY3, network function PCF-SITE1 at network node 121-4 accessible via network address XXY4, and so on as indicated by the map information 150 in FIG. 3.

5. As previously discussed, the user 108 or other suitable entity produces instructions such as in the user interface entry 131 to perform desired logging of log information at one or more network nodes and corresponding applications. For example, the user 108 uses the discovery information in communications 175 from the network resource repository 240 to generate the instructions in the user interface entry 131. That is, via the communications 175, the log management resource 141 learns of the logging service UDR-SITE1 at the network node 123 and corresponding network address XXY3 associated with that network function service. User 108 generates the user interface entry 131 to use the logging service UDR-SITE1 at the network node 121-3 by specifying the wireless network site of interest as ALPHA (i.e., SITE1) associated with the wireless network 101, service=provisioning (i.e., logging service named UDR-SITE1), between corresponding Start and End Times as specified by the logging service request. Note that the communications 176 may further include notification of log transferring actions provided by a user 108.

In other words, when executing the instructions as indicated by the user interface entry 131, a combination of the instructions #1, #2, #3, and #4 cause the log management resource 141 to communicate request communications 176 directly to the network address XXY3 for execution of a logging service (provisioning as provided by the logging service application for network function UDR-SITE1). The instructions in the user interface entry 131 can be configured to indicate the corresponding network address XXY3 as a target destination in which to communicate the respective provisioning logging service request as indicated by the user interface entry 131.

In addition to communicating the requested logging service directly from the log management resource 141 to the specified logging service application/network function UDR-SITE1 at the network node 121-3, via communications 176, the log management resource 141 can be configured to notify the network node 121-3 and/or the logging service application logging service application UDR-SITE1 that the requested logging operation associated with the user interface entry 131 is to be executed between the logging Execution Start Time: 2024-07-15 12:00:00 PM and Logging Execution End Time: 2024-07-15 12:10:00 PM.

Yet further, via communications 176, the log management resource 141 can be configured to notify the network node 121-3 and/or the logging service application UDR-SITE1 that the log file 151 generated by the logging service application UDR-SITE1 is to be communicated to the distribution resource 160 for subsequent distribution to a respective communication resource 161.

Thus, via communications 176, the log management resource 141 notifies the logging service application UDR-SITE1 to produce a respective specific type of log file 151 with corresponding log information based on collection of the requested log information (as specified by the communications 176) between the Execution Start Time: 2024-07-15 12:00:00 PM and Logging Execution End Time: 2024-07-15 12:10:00 PM.

6. Via communications 177 from the network node 121-3 and corresponding logging service application UDR-SITE1 (i.e., logging service provisioning), network node 121-3 and corresponding logging service application UDR-SITE1 acknowledges enabling and disabling of the requested logging function and receipt of the corresponding instructions indicating to transfer the corresponding generated log information associated with the request as specified by the user interface entry 131 to the distribution resource 160.

7. In the event that the distribution resource 160 is identified as a target in which to forward the log information 151 produced by the network function UDR-SITE1, logs (such as log information 151) will be pushed from the respective network function UDR-SITE1 to the distribution resource 160 after the specified end time in the request.

Note: The transferred file naming convention can use the following syntax to corelate to the request Format: Sites-NFType-ServiceName-StartTime-EndTime. e.g. Alpha-UDR-provisioning-StartTime-EndTime

Note that if there are multiple network functions discovered from the communications 175 received from the network resource repository 240, then separate log enabling requests may be sent to each of the different selected logging functions at the corresponding network nodes.

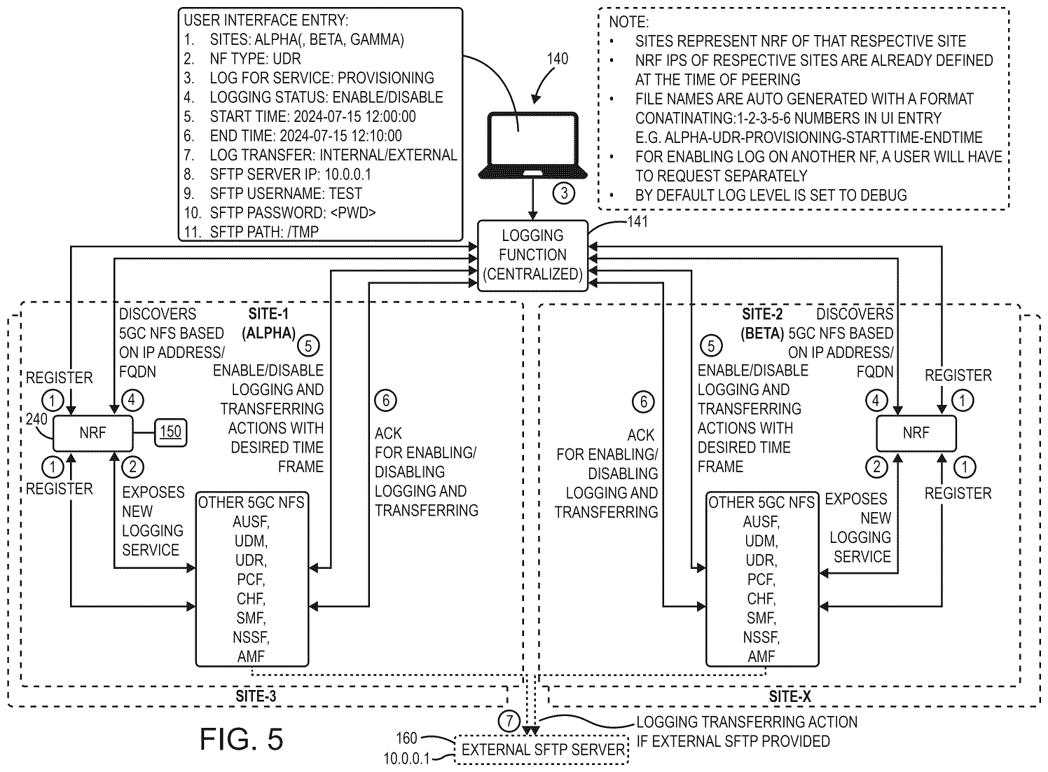

Note further that the log management resource 141 as discussed herein may be centralized such that the log management resource 141 communicates with multiple different wireless network sites. An example is shown in FIG. 5. In a centralized approach, the log management resource 141 may be paired with multiple site NRFs. A user 108 will be able to regulate logging for a particular network function type (e.g. UDR) across all or selected sites. The call flow to multiple sites is similar to a single site.

In this manner, the user 108 or other suitable entity can be configured to create different instances of user interface entry information (131) at the log management resource 141 to initiate generation of different log information from each of the different available network functions as specified by the map information 150.

As previously discussed, FIG. 3 is an example diagram illustrating implementation of log management resource and multiple network nodes at multiple sites as discussed herein.

Additionally, as previously discussed, the network repository resource 240 or other suitable entity generates the map information 150 based on the new or old log services or network functions provided by log services on each of the different network nodes.

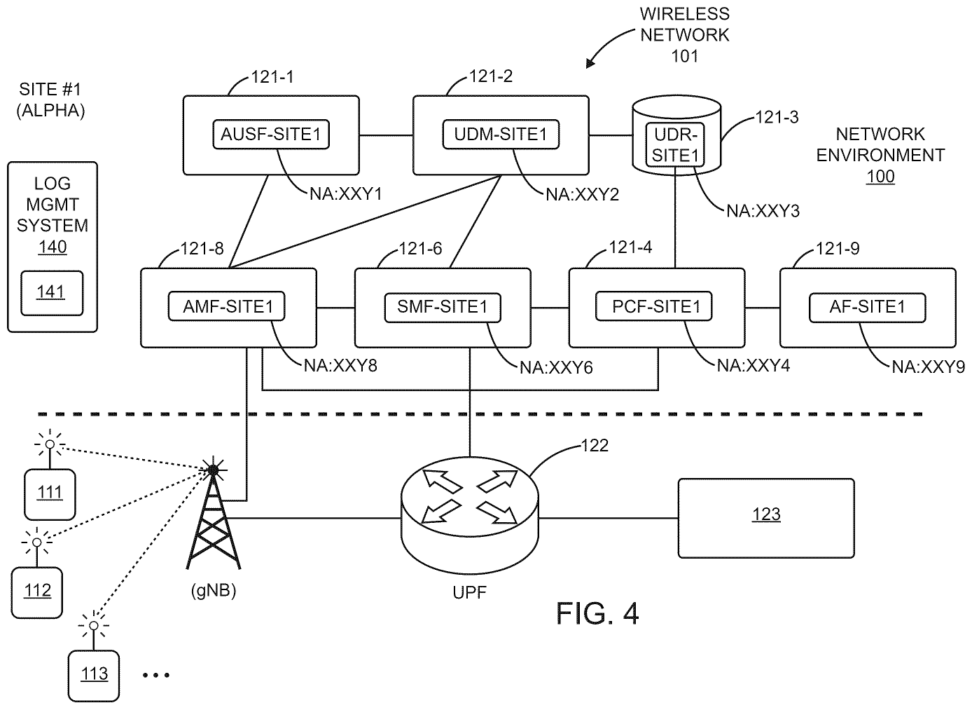

FIG. 4 is an example diagram illustrating implementation of the different logging services (network functions) provided by each of multiple different network nodes as discussed herein.

For example, as previously discussed, the network node 121-1 implements the corresponding network function AUSF-SITE1. The corresponding network address XXY1 specifies a corresponding communication interface such that the communication management system 140 or corresponding log management resource 141 can communicate directly with the network function AUSF-SITE1 via communications sent directly to the network address XXY1.

The network node 121-2 implements the corresponding network function UDM-SITE1. The corresponding network address XXY2 specifies a corresponding communication interface such that the communication management system 140 or corresponding log management resource 141 can communicate directly with the network function UDM-SITE1 via communications sent directly to the network address XXY2.

The network node 121-3 implements the corresponding network function UDR-SITE1. The corresponding network address XXY3 specifies a corresponding communication interface such that the communication management system 140 or corresponding log management resource 141 can communicate directly with the network function UDM-SITE1 via communications sent directly to the network address XXY3.

The network node 121-4 implements the corresponding network function PCF-SITE1. The corresponding network address XXY4 specifies a corresponding communication interface such that the communication management system 140 or corresponding log management resource 141 can communicate directly with the network function PCF-SITE1 via communications sent directly to the network address XXY4, and so on.

As previously discussed, FIG. 5 is a diagram of a centralized approach, where the log management resource 141 may be paired with multiple site NRFs. A user 108 will be able to regulate (control operation of) logging for a particular network function type (e.g. UDR) across all or selected sites. The call flow to multiple sites is similar to a single site.

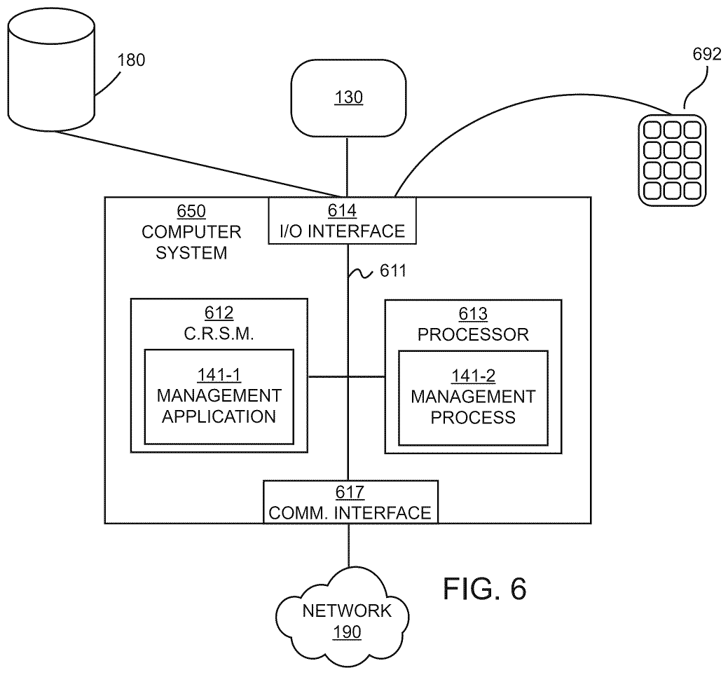

FIG. 6 is an example block diagram of a computer system for implementing any of the operations as previously discussed according to examples herein.

Note that any of the resources (such as log management system 140, log management resource 141, or any entity, etc.) as discussed herein can be configured to include computer processor hardware and/or corresponding executable instructions to carry out the different operations as discussed herein.

For example, as shown, computer system 650 of the present example includes interconnect 611 coupling computer readable storage media 612 such as a non-transitory type of media or any suitable type of computer readable hardware storage in which digital information can be stored and or retrieved, a processor 613 (computer processor hardware), I/O interface 614, and a communications interface 617.

I/O interface(s) 614 supports connectivity to repository 680 and input resource 692.

Computer readable storage medium 612 can be any hardware storage device such as memory, optical storage, hard drive, floppy disk, etc. In one example, the computer readable storage medium 612 stores instructions and/or data.

As shown, computer readable storage media 612 can be encoded with management application 140-1 (e.g., including instructions) in a respective wireless station to carry out any of the operations as discussed herein.

During operation of one example, processor 613 accesses computer readable storage media 612 via the use of interconnect 611 in order to launch, run, execute, interpret or otherwise perform the instructions in management application 140-1 stored on computer readable storage medium 612. Execution of the management application 140-1 produces management process 140-2 to carry out any of the operations and/or processes as discussed herein.

Those skilled in the art will understand that the computer system 650 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 650 may reside at any location or can be included in any suitable resource in any network environment to implement functionality as discussed herein.

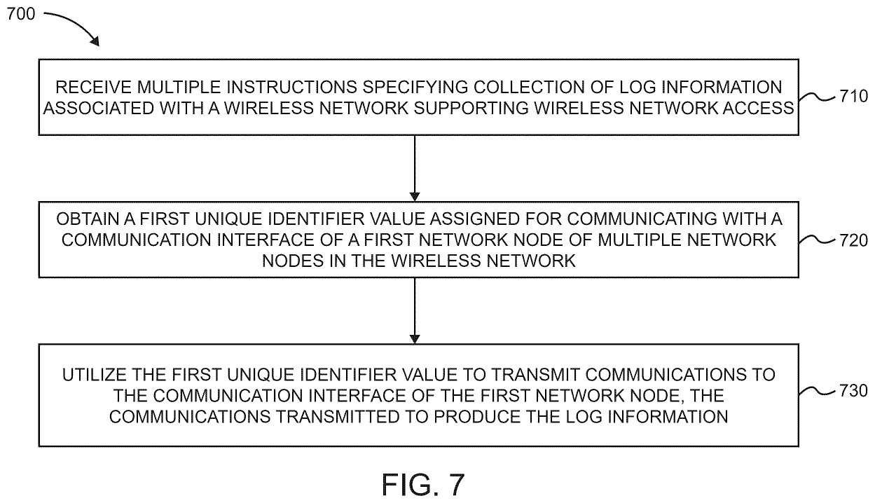

Functionality supported by the different resources will now be discussed via flowcharts in FIG. 7. Note that the steps in the flowcharts below can be executed in any suitable order.

FIG. 7 is a flowchart 700 illustrating an example method as discussed herein. Note that there will be some overlap with respect to concepts as discussed above.

In processing operation 710, the log management resource 141 receives multiple instructions in the user interface entry 131 specifying how to collect log information associated with operation of a wireless network 101 supporting wireless network access. In processing operation 720, the log management resource 141 obtains a first unique identifier value (XXY3) assigned for communicating with a communication interface of a first network node 121-3 of multiple network nodes in the wireless network 101.

In processing operation 730, the log management resource 141 utilizes the first unique identifier value XXY3 to transmit communications to the communication interface of the first network node 121-3. The log management resource 141 transmits the communications 176 to produce the log information 151.

Note again that techniques herein are well suited to facilitate processing of available physical infrastructure information and generation of a proposed wireless network installation plan for implementation of the new wireless network. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

We claim:

1. A method comprising:
receiving multiple instructions specifying collection of log information associated with a wireless network supporting wireless network access;
obtaining a first unique identifier value assigned for communicating with a communication interface of a first network node of multiple network nodes in the wireless network; and
utilizing the first unique identifier value to transmit communications to the communication interface of the first network node, the communications transmitted to produce the log information.

2. The method as in claim 1, wherein the communication interface is assigned to a wireless network function at the first network node supporting collection of the log information.

3. The method as in claim 1, wherein the multiple network nodes support wireless connectivity of multiple mobile communication devices to a remote network through a wireless base station of the wireless network.

4. The method as in claim 3, wherein the log information is derived from monitoring operations associated with the first network node, the first wireless network node supporting the wireless connectivity between the mobile communication devices and the remote network.

5. The method as in claim 1, wherein obtaining the first unique identifier value includes:
transmitting notification of an identity of a logging service to a management entity, the management entity operative to map the identity of the logging service as specified by the notification to a first network address assigned to the communication interface; and
in response to transmitting the notification, receiving the first unique identifier value from the management entity.

6. The method as in claim 5, wherein utilizing the first unique identifier value to transmit communications to the communication interface of the first network node includes transmitting the communications to the first network address, the communications including log commands controlling generation of the log information.

7. The method as in claim 1, wherein utilizing the first unique identifier value to transmit the communications includes:
transmitting a first communication to a logging service associated with the communication interface, the first communication including the first unique identifier value as a destination in which to deliver the first communication, the first communication notifying a logging service associated with the communication interface of a time range in which to collect the log information.

8. The method as in claim 7, wherein utilizing the first unique identifier value to transmit the communications includes:
as indicated by a first instruction of the multiple instructions, controlling an enable/disable operational state of the logging service.

9. The method as in claim 1 further comprising:
via the communications transmitted to the communication interface of the first network node, notifying a logging service at the first network node of a storage location in which to store the collection of log information.

10. The method as in claim 1, wherein the communications transmitted to the first network node cause a logging function associated with the first unique identifier value to produce the log information.

11. The method as in claim 10, wherein the logging function is operative to produce a file including the log information, the log service operative to produce a filename associated with the file based on log collection as specified by the multiple instructions.

12. A system comprising:
log management hardware operative to:
receive multiple instructions specifying collection of log information associated with a wireless network supporting wireless network access;
obtain a first unique identifier value assigned for communicating with a communication interface of a first network node of multiple network nodes in the wireless network; and
utilize the first unique identifier value to transmit communications to the communication interface of the first network node, the communications transmitted to produce the log information.

13. The system of claim 12, wherein the communication interface is assigned to a wireless network function at the first network node supporting collection of the log information.

14. The system of claim 12, wherein the multiple network nodes support wireless connectivity of multiple mobile communication devices to a remote network through a wireless base station of the wireless network.

15. The system of claim 12, wherein the log information is derived from monitoring operations associated with the first network node, the first wireless network node supporting the wireless connectivity between the mobile communication devices and the remote network.

16. The system of claim 12, wherein the log management hardware is further operative to:
transmit notification of an identity of a logging service to a management entity, the management entity operative to map the identity of the logging service as specified by the notification to a first network address assigned to the communication interface; and
in response to transmitting the notification, receive the first unique identifier value from the management entity.

17. The system of claim 12, wherein the log management hardware is further operative to:
transmit communications to the communication interface of the first network node includes transmitting the communications to the first network address.

18. The system of claim 12, wherein the log management hardware is further operative to:
transmit a first communication to a logging service associated with the communication interface, the first communication including the first unique identifier value as a destination in which to deliver the first communication, the first communication notifying a logging service associated with the communication interface of a time range in which to collect the log information.

19. The system of claim 18, wherein the log management hardware is further operative to:
as indicated by a first instruction of the multiple instructions, control an enable/disable operational state of the logging service.

20. The system of claim 12, wherein the log management hardware is further operative to:
via the communications transmitted to the communication interface of the first network node, notify a logging service at the first network node of a storage location in which to store the collection of log information.

21. The system of claim 12, wherein the communications transmitted to the first network node cause a logging function associated with the first unique identifier value to produce the log information.

22. The system of claim 12, wherein the logging function is operative to produce a file including the log information, the log service operative to produce a filename associated with the file based on log collection as specified by the multiple instructions.

23. Computer-readable storage hardware having instructions stored thereon, the instructions, when carried out by computer processor hardware, cause the computer processor hardware to:
receive multiple instructions specifying collection of log information associated with a wireless network supporting wireless network access;
obtain a first unique identifier value assigned for communicating with a communication interface of a first network node of multiple network nodes in the wireless network; and
utilize the first unique identifier value to transmit communications to the communication interface of the first network node, the communications transmitted to produce the log information.
